(19) United States
(12) Patent Application Publication
(10) Pub. No.: US 2010/0290568 A1
(43) Pub. Date: Nov. 18, 2010

(54) DECODING FREQUENCY CHANNELISED SIGNALS

(76) Inventors: Hajime Suzuki, Epping (AU); Graham Ross Daniels, New South Wales (AU); Mark Hedley, New South Wales (AU)

Correspondence Address: NIXON & VANDERHYE, PC, 901 NORTH GLEBE ROAD, 11TH FLOOR, ARLINGTON, VA, 22203, US

(21) Appl. No.: 12/295,420

(22) PCT Filed: Mar. 31, 2006
(86) PCT No.: PCT/AU06/00429

§ 371 Date: Aug. 5, 2009

(51) Int. Cl. H04B 7/10

(52) U.S. Cl. 375/341; 375/347

(57) ABSTRACT

There is disclosed a method and receiver for decoding a data signal from analogue signals received at one or more receiving antennas (24). The decoding is performed on the basis of bit value probabilities (66) derived from an effective signal to noise ratio (ESNR) (64) and a respective symbol error value (SEV) (62) calculated for all of the one or more receiving antennas. The ESNR is calculated utilising signal to noise ratios (SNRs) (58) per sub-channel and sub-channel transfer functions (60) measured for each of the one or more receiving antennas (24). Also, the SEVs are calculated utilising the measured sub-channel transfer functions.

### FIELD OF THE INVENTION

The present invention relates to digital communications and more particularly to decoding frequency channelised signals received by one or more antennas on the basis of bit value probabilities.

### BACKGROUND

Wireless communication systems are widely used for transmission of digital signals, for example in cellular phone communication and the transmission of digital television. One method of implementing a wireless communication system of this type is to use a singular antenna at each of the transmitter and receiver ends. Such systems generally operate satisfactorily in free space environments where there is a direct (line-of-sight) path from the transmitter to the receiver. However, in some environments, such as urban space where infrastructure creates obstructions to the line of sight between transmitter and receiver, the direct path may be partially or completely blocked, and the transmitted signal may undergo scattering and diffraction from such obstructions (obstacles) before it is received. Importantly, the effects of scattering and diffraction are often not homogeneous across the spectral bandwidth of the signal because the signal travels between the transmitter and receiver via multiple paths. As the distance of each path may vary, so too does the delay experienced by each of the signal's multiple path components. For the present purposes these effects are referred to as multipath scattering. If the transmitter, receiver and obstacles are in relative motion, then the results of such multipath scattering become time varying.

The delays introduced by multipath scattering may result in a transmitted symbol being received over a period longer than the transmitted symbol period. Thus, part of the symbol energy will interfere with the received energy of adjacent received symbols, known as intersymbol interference. If the effects of intersymbol interference are significant enough, they may introduce errors into the interpretation of adjacent symbols. As each symbol transmitted is susceptible to multipath scatter, so too is every symbol affected by intersymbol interference. A related problem occurs where signal components following different paths destructively interfere, resulting in signal fading.

An approach to alleviating this problem is the channelisation of data at the transmitter into multiple concurrent data streams (data sub-channels). One implementation providing multipath tolerance is orthogonal frequency division multiplex (OFDM) where a single channel is separated into frequency sub-bands (sub-channels). Another approach is used in code division multiplex (CDM) systems that achieve code diversity by using multiple spreading codes.

Multiple-input multiple-output (MIMO) wireless communication systems are another recent approach of not only reducing the degrading effects of multipath scattering but also potentially increasing the spectral efficiency of the system. MIMO systems utilise the effects of spatially separating a plurality of antennas at both the transmitting and receiving ends of a communication system. There are a number of different methods for implementing a MIMO system which maximise different benefits (see A. J. Paulraj, D. A. Gore, R. U. Nabar, and H. Bolcskei, “An overview of MIMO communications—A key to gigabit wireless,” Proceedings of the IEEE, vol. 92, no. 2, pp. 198-218, February 2004). For example, a diversity gain may be realised by transmitting differently encoded versions of the same data from each of the spatially separated transmitters in unison. Ideally, each of the transmitter-receiver combinations creates a propagation sub-channel which fades independently of the other combinations. By suitably combining and decoding the signals received at each of the receiver antennas, the resulting data stream exhibits less impairment due to fading than the equivalent single-input single-output (SISO) implementation without increasing transmission time or bandwidth.

In another implementation, a MIMO system may exploit the benefit of spatial multiplexing to increase capacity without increasing transmission power or bandwidth requirements. Such a gain is realised by splitting a serial signal into a plurality of independent signals which are then transmitted in parallel from each of the independent transmitters. The data rate of each of the parallel transmission signals is less than the original serial signal data rate, which has the additional benefit of reducing the effects of intersymbol interference within the parallel channel. In this implementation, the receiver system combines the information from the parallel received signals to recover the transmitted data at the original (higher) data rate.

In any channelised communications system, it is preferable that some form of error resistant coding is employed to allow errors in the received signal to be detected and corrected, or the data content of the signal to be estimated more reliably, particularly since some sub-channels typically suffer greater impairment than others. A Low Density Parity Check (LDPC) code is one such type of coding (see, for example, R. G. Gallager, “Low-density parity-check codes”, IRE Transaction on Information Theory, vol. 8, no. 1, pp. 21-28, January 1962). Parity check codes, as a general rule, work by combining a block of binary information bits with a block of check bits. Each check bit represents the modulo 2 sum of a prescribed selection of the binary bits which constitute the information digits. For example, if the data bits [x₁, x₂, . . . , x₅] have parity check bits [x₆, x₇, x₈] appended to make a 8 digit coded block, x₆ may be defined as

x₆=x₁⊕x₄⊕x₅

If the parity check equation defining each parity check bit is chosen correctly, then errors can be detected and corrected. The above parity check equation may be represented by the matrix:

$$[ \begin{matrix}1 & 0 & 0 & 1 & 1 & \vert & 1 & 0 & 0\end{matrix} ] \\ \begin{matrix}{x}_{1} & {x}_{2} & {x}_{3} & {x}_{4} & {x}_{5} & \vert & {x}_{6} & {x}_{7} & {x}_{8}\end{matrix}$$

A parity check code usually is derived from a number of such parity check equations, which are normally represented as the individual rows of a parity check matrix. The code may be described in terms of a generator matrix which is used to generate code word vectors from data word vectors by modulo 2 matrix multiplication (also known as mapping).

A LDPC code comprises a number of parity check equations, which normally are represented as the individual rows of a parity check matrix. The LDPC matrix is dominated by 0's, with only a small number of 1's. A regular LDPC code may be described as an (a, b, c) code whereby the matrix of the code has a block length of a, each column of the matrix contains a small fixed number of b 1's, and each row a small fixed number of c 1's. A regular LDPC code has the same number of 1's in each column or row, whereas for an irregular LDPC code, some variation is permitted. In a systematic code, the data bits are explicitly identifiable in the code words, but this is not always the case. The modulo-2 dot product of a valid code word with any of the rows in the parity check matrix should equal zero.

The outline given above, and the following detailed description, refer to a systematic LDPC code in which each parity check bit is a function of the data bits only. It should be noted that the more general cases of systematic codes in which parity check equations contain more than one check bit, or of non-systematic codes may be treated similarly, and are equally applicable coding approaches. In the most basic (error detection) implementations, a data packet consisting of a stream of bits forming one or more data words is encoded by multiplying the data words by the generator matrix. At the receiver end, the message is checked for accuracy by verifying the modulo 2 product of each code word and the parity check matrix to be the zero vector. If there are no errors, the code words may be multiplied by an inverse of the generator matrix to extract the original data words. An error correcting decoder uses the parity check results to find the valid code words which are “nearest” to the received code words.

Soft decision LDPC decoders accept a sequence of bit value (0,1) estimates and associated correctness probability estimates, the pairs normally being combined as single values representing the estimated prior probabilities that the associated bit is a 1. These estimates correspond to the information and check (redundancy) bits of the received message, and they are employed by the decoder to generate a more reliable estimate of the message bits, normally via an iterative process.

It is therefore possible and desirable to increase the reliability of decoders (such as LDPC decoders) by providing more accurate probability estimates.

### SUMMARY

In a broad aspect, there is provided a method and receiver for decoding a data signal from analogue signals received at one or more receiving antennas, said decoding being performed computationally on the basis of bit value probabilities derived from an effective signal to noise ratios (ESNR) and a respective symbol error value (SEV) for all said one or more receiving antennas, said ESNR being calculated utilising signal to noise ratios (SNRs) per sub-channel and measured sub-channel transfer functions for each of said one or more receiving antennas, and said SEVs being calculated utilising said transfer functions.

There is further disclosed a method for decoding a data signal comprising the steps of: receiving one or more transmitted signals at each of one or more receiving antennas, each said transmitted signal having multiple frequency sub-channels containing data symbols; calculating a signal to noise ratio (SNR) per sub-channel for all said one or more receiving antennas' respective received signal; measuring channel transfer functions for each of said one or more receiving antennas; calculating an effective signal to noise ratio (ESNR) for all said one or more receiving antennas utilising a respective said SNR and a respective said channel transfer function; calculating symbol error values (SEVs) for all said one or more receiving antennas utilising a respective said channel transfer function and a respective estimated value of said data symbols; deriving bit value probabilities utilising said ESNR and a respective said SEV; and decoding said data signal utilising said derived bit value probabilities.

There is yet further disclosed a receiver for decoding a data signal comprising: one or more receiving antennas receiving one or more transmitted signals, each said transmitted signal having multiple frequency sub-channels containing data symbols; a circuit calculating a signal to noise ratio (SNR) per sub-channel for each said one or more receiving antennas' respective received signal; a circuit measuring channel transfer functions for each of said one or more receiving antennas; a circuit calculating an effective signal to noise ratio (ESNR) for all said one or more receiving antennas utilising a respective said SNR per sub-channel and a respective said channel transfer function; a circuit calculating symbol error values (SEVs) for all said one or more receiving antennas utilising a respective said channel transfer function and a respective estimated value of said data symbols; a circuit deriving bit value probabilities utilising said ESNR and a respective said SEV; and a decoder decoding said data signal utilising said derived bit value probabilities.

Preferably, calculating the SEVs includes determining the distance of the estimated symbol values from a predetermined ideal constellation point.

Further preferably, calculating the SNRs per sub-channel includes sampling each receiving antenna's received signal at each of a first period when there are no data symbols present and a second period when there is at least one data symbol present, determining the variance of the received signals over the duration of the first period and the variance of the received signals over the duration of the second period for each receiving antenna, and calculating the SNR per sub-channel for each receiving antenna utilising said variances. Advantageously, the SNR per sub-channel is determined by determining the difference between the first period variance and the second period variance, and dividing said difference by the first period variance.

The decoding can utilise low density parity check decoding. Alternatively, the decoding can be Viterbi or turbo decoding.

The received signals can be converted from the time domain to the frequency domain before calculating the SNRs. The conversion, in one form, is performed by an inverse Fast Fourier transformation (IFFT) process.

Preferably, the sub-channels are encoded by orthogonal frequency division multiplex modulation.

### DESCRIPTION OF THE DRAWINGS

FIG. 1 is a block schematic of a MIMO communication system incorporating an LDPC encoder and corresponding decoder.

FIG. 2 is a flow diagram of the steps of decoding a signal received in a MIMO system.

FIG. 3 is a QPSK Gray labelled mapping constellation of symbols which may be transmitted by MIMO-OFDM.

FIG. 4 is a screenshot of a system implementing the method of LDPC decoding using the SNR calculated according to the steps of FIG. 2.

### DETAILED DESCRIPTION

Where reference is made in any one or more of the accompanying drawings to steps and/or features, which have the same reference numerals, those steps and/or features have for the purposes of this description the same functions and/or operations, unless the contrary intention appears.

### INTRODUCTION

In the following description, an implementation using orthogonal frequency division multiplexing (OFDM) in a MIMO communication system using LDPC encoding/decoding is given. However, it is to be understood that the invention applies generally to other frequency channelised communications systems that rely on decoding a received signal using estimates of bit probabilities.

OFDM is a communication technique often utilised in wireless communication systems. OFDM may be combined with arrays of antennas at both the transmitting and receiving ends to enhance the system capacity on frequency selective channels, and in such case is referred to as a MIMO-OFDM system. The use of MIMO-OFDM is presently being considered for use in the IEEE 802.11 Wireless LAN standards. In particular, MIMO-OFDM is proposed in an amendment to the standard to be known as 802.11n for higher throughput improvements to wireless communications. The 802.11n standard will build upon previously accepted standards such as 802.11a and 802.11g which utilise OFDM.

In a MIMO-OFDM system, the bandwidth available for communication is divided into frequency domain sub-channels that are orthogonal to one another at the chosen symbol rate. This is beneficial as it converts the frequency selective MIMO channel into a set of parallel, MIMO sub-channels, each of which is essentially frequency-flat. In OFDM the sub-channel carrier frequencies are spaced in the frequency domain to ensure that the corresponding time domain signals are orthogonal on a symbol-by-symbol basis, whilst allowing the spectrum of each of the sub-carrier signals to overlap the spectra of signals in adjacent sub-channels.

### Transmitter and Receiver Circuits

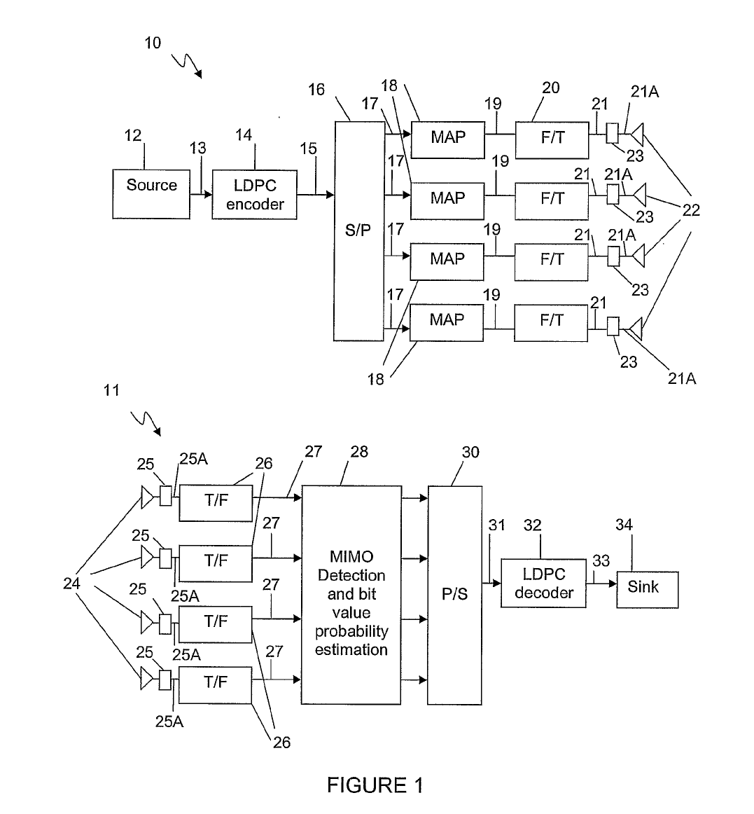

Referring to FIG. 1 there is shown a block schematic of the transmitter end 10 and the receiver end 11 of a MIMO-OFDM communication system. In the transmitter end 10, the data signal consisting of a binary data sequence 13 to be transmitted is output by a source 12. An LDPC encoder 14 is used to encode the data signal 13 to be transmitted. The encoded data signal 15, now containing additional check bits, is fed into a serial to parallel (S/P) converter 16. The encoded data signal 15 is split (de-multiplexed) by the S/P converter 16 prior to transmission so that each de-multiplexed component data stream 17 is transmitted concurrently from a different one of the transmission antennas 22. Each of the component data streams 17 is mapped by a respective mapping device 18 into sets of k 2^{m}=M-ary QAM modulation symbols 19, corresponding to the OFDM carriers, using Gray-labelling. The symbols 19 are converted into time domain OFDM symbols 21 by respective F/T transformation (eg. inverse Fast Fourier Transform (IFFT)) circuits 20.

The OFDM symbol streams 21 are fed into time domain reconstruction circuits 23 to generate corresponding analogue radio frequency (RF) signals 21A. The reconstruction circuits 23 may comprise any or all of a digital to analogue converter (DAC, not shown), a frequency translator (such as a mixer, not shown) and at least one frequency domain filter (not shown). In a basic implementation, the digital signal sequence corresponding to OFDM symbols 21 is firstly converted to a complex analogue signal by the DAC. A low pass filter (not shown) may be applied to the DAC output to smooth the signal. The smoothed signal is then frequency translated, for example, by an image reject mixer coupled to a local oscillator (not shown). The frequency translation process produces a signal at the desired higher (e.g. radio) frequency range. In another implementation, the analogue complexity may be reduced by placing the DAC after the mixer, such that the frequency-translation occurs in the digital domain, although this somewhat increases the computational complexity of the signal reconstruction. It will be apparent to those skilled in the art that various different reconstruction circuits 23 may be utilized to generate the reconstructed RF signal 21A. The reconstructed RF signals 21A then are transmitted via the plurality of antennas 22.

At the receiver end 11, the transmitted analogue RF signals 21A corresponding to the concurrent OFDM symbols 21 are received via the plurality of antennas 24 and passed through respective time domain sampling circuits 25 whose function will be described below. The sampling circuits essentially perform the inverse task of the reconstruction circuits 23. The sampling circuit 25 may comprise any or all of a frequency translator (such as a mixer, not shown), filters (not shown) and an analogue-to-digital converter (ADC, not shown). The received analogue RF signals are frequency-translated to obtain lower, intermediate or baseband frequencies by the frequency translator, which may comprise a mixer coupled to a local oscillator. The frequency translated signal is passed through a filter to attenuate unwanted signal components. The translated, filtered signal is converted into the digital, sampled signal by the ADC. It will be apparent to those skilled in the art, that other configurations of sampling circuits may be substituted for the embodiment described.

The receiver end 11 utilises the following method to recover the data signal 13 within the signals transmitted from the transmitter antennas 22. However, not all the following steps need to be practised in accordance with the invention in its broadest form. The analogue signal received by each of the receiver antennas 24 and is sampled by the respective sampling circuits 25 during periods when there are no received symbols (i.e. ‘noise only’) and when there are received data symbols (i.e. ‘data+noise’). The resultant sampled signals 25A are converted into the frequency domain by respective time/frequency (T/F) transformation circuits 26. The conversion to the frequency domain can be performed by applying a FFT process to the received time domain sampled signal. The sets of frequency domain samples 27 corresponding to OFDM sub-channel composite values due to all transmitters are sent to a MIMO detector 28. The MIMO detector 28 can be implemented as a discrete circuit, a programmed microprocessor circuit or as an application specific integrated circuit.

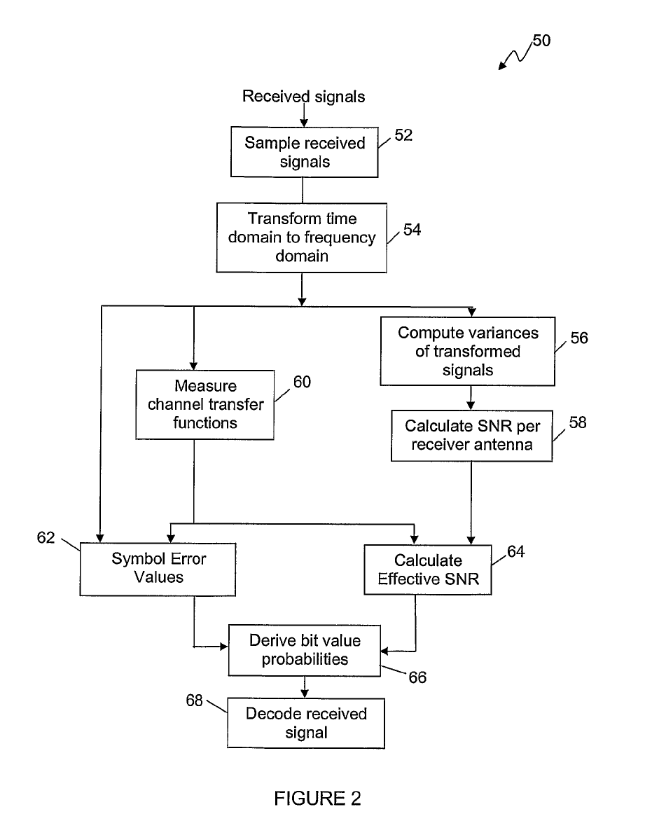

A number of processes occur during MIMO detection (as is described in detail with reference to FIG. 2). In particular, the sampled frequency domain samples 27 are used to compute the variances for each frequency component of the received signal, and subsequently utilized to calculate the corresponding Signal-to-Noise ratios (SNRs), Symbol Error Values (SEVs) and effective signal to noise ratios (ESNRs). Also, the samples 27 are used to estimate the symbol error values corresponding to each of the one or more possible transmitted symbol values. The MIMO detector 28 thus provides a soft decision for each component bit of each of the concurrently received OFDM symbols. The soft decision results are cyclically multiplexed by a multiplexer 30 (ie. a parallel to serial (P/S) conversion) into a single composite stream 31 and passed into a LDPC decoder 32.

The LDPC decoder 32 takes the output of the MIMO detector 28 to form estimates of the transmitted information bits, which it outputs as a binary stream 33 of the received data bits to a sink 34. These estimates are more reliable than known arrangements.

In the example of FIG. 1, a four transmitter antenna×four receiver antenna arrangement (10,11) is shown. It is also to be understood that other numbers of transmitters and receivers can be supported. For example, in the mathematical treatment (discussed later) the number of receiver antenna 24 is required to be equal to or greater than the number of transmitter antenna 22.

### Processing to Derive Bit Value Probabilities

Referring now to FIG. 2, there is illustrated a flow diagram 50 of the steps taken in decoding the received signals according to an embodiment of the invention. To accurately decode the transmitted binary data sequence 15 based upon the received and demodulated signal 27, it is important that the decoder 32 receives an accurate estimate of the reliability (and hence probability of correctness) of the estimate of each data or check bit.

As noted above with reference to FIG. 1, the transmitted OFDM signals (21A) are received by a plurality of antennas 24, and time sampled, via each of the plurality of sampling circuits 25 (step 52). The received signals 25A are sampled in the time domain during periods when there are no received symbols (i.e. ‘noise only’) and also when there are received symbols (i.e. ‘data+noise’). Furthermore, the period of sampling of noise only may occur before or after a received packet. Each of the parallel received sampled signals is then transformed into the frequency domain by the respective T/F circuits 26 (step 54).

The result of step 54 forms three subsequent process branches in FIG. 2. In one branch, variances per receiver per OFDM sub-carrier of the received signals are computed (step 56) from the transformed frequency domain signals 27. The variances of each signal received per receiver per OFDM sub-carrier are calculated during the ‘noise only’ period as well as the ‘data+noise’ period. The ‘noise only’ variance per receiver per OFDM sub-carrier may be expressed as N(j, k), where j is an index of the receiver and k is an index of the OFDM sub-carrier frequency. Similarly, the ‘data+noise’ signal variance may be expressed as S(j, k). The computed variances are used to calculate the SNR per OFDM sub-channel per receiver antenna (step 58).

In a second branch of FIG. 2, the frequency domain signals 27 are utilised to measure the propagation sub-channel transfer functions corresponding to each transmitter-receiver antenna pair (step 60).

In the third branch, the frequency domain signals 27 resulting from step 54 are used—together with the measured propagation sub-channel transfer functions (S-CTFs) resulting from step 60—to estimate the SEVs corresponding to the LDPC-encoded data symbols (step 62). The SEVs are the distances of the estimated (I,Q) symbol values from the (predetermined/known) ideal constellation points.

The S-CTFs resulting from step 60 also are used with the calculated SNR per receiver per OFDM sub-carrier to calculate an estimated signal to noise ratio (ESNR) (step 64). The ESNR is a measure of the signal to noise per transmitter antenna.

The SEVs resulting from step 62 and calculated ESNRs resulting from step 64 are utilised to derive a sequence of bit value probabilities (step 66) corresponding to the bit value sequence of the received OFDM signals per receiver. The bit value probabilities are passed to the LDPC decoder 32, and the received signal is decoded (step 68) to produce a best estimate of the transmitted binary data sequence 13.

With reference to the foregoing description of method 50, it will be apparent to those skilled in the art that other embodiments are achievable. For example, the step of measuring the propagation sub-channel transfer functions (step 60) cay be done at any time after the signals are received by the receiver 24 and before estimating the SEVs (step 62) or calculating the ESNR (step 64). Furthermore, it should be evident that the sampling of the ‘noise only’ and ‘data+noise’ signals may be considered as independent of one another, and hence they may occur in any order. Also, transforming the sampled signals into the frequency domain (step 54) and computing the variances of the ‘noise only’ and ‘data+noise’ signals may occur in series or in parallel, and in any order, without affecting the calculated SNR. The sampling periods (steps 52) are each chosen to be long enough that the power averages (variances) have sufficiently low uncertainty to give SNR estimates of acceptable accuracy.

### Mathematical Analysis

The following is a mathematical analysis of how the frequency domain signals 27 (step 54) and measured transfer functions (step 60) are utilized in decoding the received signals 25A. Although the analysis is not strictly presented in the same order as the method steps of FIG. 2, it will be apparent to those skilled in the art that the mathematical analysis can be implemented to perform the preferred arrangement illustrated in FIG. 2.

Suppose nₜ transmitters and nᵣ receivers are used in a MIMO-OFDM system, where nᵣ≧nₜ. Also assume that n_{f} OFDM data sub-carriers are used to transmit nₛ OFDM symbols at each transmitter. The transmitted signal at the ith transmitter, kth OFDM sub-carrier, and lth OFDM symbol is x(i, k, l), where i=1 . . . nₜ, k=1 . . . n_{f}, and l=1 . . . nₛ. The received data signal and noise signal at the jth receiver, kth OFDM sub-carrier, and lth OFDM symbol are r(j, k, l) and n(j, k, l), respectively, where j=1 . . . nᵣ. The propagation sub-channel transfer function, H(i, j k), describes the transmission characteristics between the ith transmitter and jth receiver at the kth OFDM sub-carrier, where the channel is assumed to be stationary for the duration of nₛ OFDM symbols. The received signal may thus be expressed as

$$r ( j , k , l ) = {\sum }_{i = 1}^{{n}_{t}} H ( i , j , k ) x ( i , k , l ) + n ( j , k , l ) \qquad ( 1 )$$

The above equation can be written in a vector-matrix form as

r(k,l)=H(k)x(k,l)+n(k,l) (2)

Recalling that nᵣ is the number of receivers and nₜ is the number of transmitters, r(k, l) is an nᵣ×1 column vector whose jth element is r(j, k, l), H(k) is an nᵣ×nₜ matrix whose jth row and ith column element is H(i, j, k), x(k, l) is an nₜ×1 column vector whose ith element is x(i, k, l), and n(k, l) is an nᵣ×1 column vector whose jth element is n(j, k, l).

H(k) is normally estimated by measurements of the received signals produced by the transmission of known and unique reference signals from each of the transmitters. In this example, as is often convenient, H(k) will be assumed to be normalised such that var[x(i,k,l)], averaged over l is considered to be unity.

If a zero-forcing (ZF) approach is used for the MIMO detection, the reconstructed estimate of the transmitted signals, z(k, l), is given by

z(k,l)=W(k)r(k,l)=x(k,l)+W(k)n(k,l) (3)

where W(k) is an nₜ×nᵣ matrix whose ith row and jth column element is W(i, j, k) and z(k,l) is an nₜ×1 vector whose ith element is z(i, k, l). W(k) is a left inverse of H(k), meaning that

W(k)H(k)=1 (4)

A possible set of matrices, W(k) is given by

W(k)=(H(k)^{H}H(k))⁻¹H(k)^{H} (5)

The above set is the unique set of inverses if nᵣ=nₜ. If nᵣ>nₛ, there are an infinite number of left-inverses. In the latter case, this set (of generalised inverses) is optimal for the case of equal noise power at each receiver.

Assume that, after LDPC coding of the binary data stream to be transmitted, M-QAM sub-channel modulation is used, and at the receiver system 11, a zero-forcing MIMO orthogonalisation (detection) process is employed (i.e. the MIMO detector 28), followed by a soft-decision LDPC decoder 32.

### Bit Value Probabilities

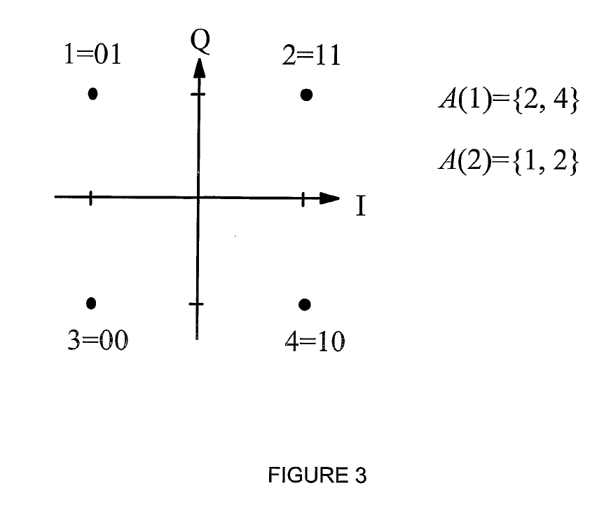

The bit value probability (resulting from step 66) P(b, i, k, l) that the bth bit within the M-QAM symbol sent from the ith transmitter, on the kth OFDM sub-carrier, and in the lth OFDM symbol is a 1, is given by

$$P ( b , i , k , l ) = {\sum }_{q ∈ A ( b )} p ( i , k , l , q ) \qquad ( 6 )$$

where A(b) is the set of indices in the range q=1 . . . 2^{m} for which the bth bit in the corresponding element of the M-QAM alphabet is 1. An example of A(b) is given in FIG. 3 where A(b) is given for Gray-labelled mapping of QPSK. In the above equation, p(i, k, l, q) is the probability that the qth element is sent from the ith transmitter, at the kth OFDM sub-carrier, and at the lth OFDM symbol, and is given by

$$p ( i , k , l , q ) = \frac{{p}^{′} ( i , k , l , q )}{{\sum }_{q = 1}^{{2}^{m}} {p}^{′} ( i , k , l , q )} \qquad ( 7 )$$

where p′(i,k,l,q) represents the probability density of the SEVs.

The probability density of the SEV is known, for the case of additive white Gaussian noise (AWGN), to be given by

$${p}^{′} ( i , k , l , q ) = α ( {η}^{′} ( i , k ) ) \cdot exp ( - \frac{{d ( i , k , l , q )}^{2}}{2 {η}^{′} ( i , k )} ) \qquad ( 8 )$$

In the above equation, α(η′(i,k)) is a scale factor. Therefore, to derive the bit value probabilities, P(b, i, k, l) using the above equation, it is necessary to determine the SEVs d(i, k, l, q) and the ESNR, 1/η′(i,k).

### Symbol Error Values

The SEVs, d(i,k,l,q), of the M-QAM symbol transmitted from the ith transmitter, on the kth OFDM sub-carrier, in the lth OFDM symbol, corresponding to the qth element of the M-QAM alphabet is given by

d(i,k,l,q)=|z(i,k,l)−a(q)| (9)

In the above equation, z(i,k,l) is the sub-channel symbol value estimate using the zero-forcing process, and a(q) is the value of the qth element (symbol) in the chosen M-QAM alphabet, where q=1 . . . 2^{m}. Under the assumption of a normalized H(k), the a(q) are scaled such that var[a(q)] is unity.

### Effective Signal to Noise Ratio

The ESNR is the reciprocal of the effective noise factor, which is the noise variance per dimension of signal space (for a complex scalar QAM signal, the dimensionality is 2 corresponding to the independent real and imaginary components), consistent with the scaling of the SEVs. Since the zero forcing process forms weighted sums of the receiver outputs, the effective noise factor is given by:

$${η}^{′} ( i , k ) = {\sum }_{j = 1}^{{n}_{r}} [ {\vert W ( j , i , k ) \vert}^{2} \cdot η ( j , k ) ] \qquad ( 10 )$$

where η(j,k) is the noise variance per dimension of signal space at the jth receiver and kth OFDM sub-carrier, and is given by

$$η ( j , k ) = \frac{{\sum }_{i = 1}^{{n}_{t}} {\vert H ( i , j , k ) \vert}^{2}}{γ \cdot snr ( j , k )} \qquad ( 11 )$$

where γ (=2 for this case of complex scalars) is the dimensionality of the signal space. The sum in the above equation corresponds to the total signal power (signal variance) of the kth OFDM sub-carrier at the jth receiver, due to all transmitters. To determine the noise variance according to the above equation, it is also necessary that an estimate of the SNR, snr(j,k) be calculated.

### Signal to Noise Ratio

The SNR per OFDM sub-carrier per receiver is given by

$$snr ( j , k ) = \frac{S ( j , k ) - N ( j , k )}{N ( j , k )} \qquad ( 12 )$$

where S(j,k) and N(j,k) have been previously defined as the variance of ‘data+noise’ signals and ‘noise’ signal, respectively, and the variances are of complex signals averaged over time.

The bit value probabilities P(b, i, k, l) of the data bits and LDPC check bits are fed into the LDPC decoder 32 which uses them to generate a better estimate of the sequence of data bits actually transmitted. This estimate makes use of the data redundancy introduced by the LDPC check bits.

### Example

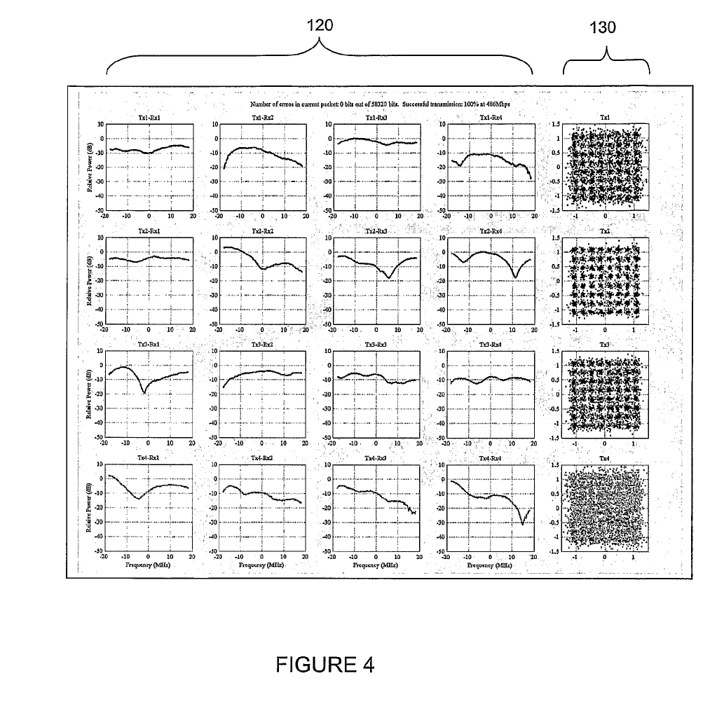

Referring now to FIG. 4 there is illustrated the received signal characteristics corresponding to a MIMO-OFDM packet transmission. Referring also to Appendix A, there is provided an embodiment of the present invention implemented in MATLAB™ code, which when practised gives results consistent with those shown in FIG. 4.

In the example shown, an aggregate data rate of transmission of 486 Mbps is used. A configuration of four transmitters 22 and four receivers 24 utilise a 40 MHz bandwidth comprising 108 OFDM carriers. The carriers are modulated using 64 QAM to achieve 12 bps/Hz. The 16 graphs 120 shown on the left of FIG. 4 illustrate the frequency response of each of the links between transmitter-receiver pairs in a MIMO configuration of 4 transmitters and 4 receivers. The four graphs 130 shown on the right are the 64 QAM constellations reconstructed from the received signals by the zero forcing process. It can be seen that system and environmental noise corrupts the received symbols and deviates them from the true 64 QAM symbol constellation. The received signal was used in the embodiment described above to estimate the SNR per receiver per sub-carrier and from these estimates to derive the ESNR per data sub-channel per sub-carrier, and thence to provide more reliable estimation of bit error probabilities to an LDPC decoder. The data bit sequences produced by the LDPC decoder from this information contained no errors, based on a comparison against the transmitted data signal.

For the LDPC decoder tested, that utilised the standard belief propagation decoding algorithm, it was empirically found that a sampling period of 20 symbols was sufficient to accurately determine the transmitted signal. Here an irregular LDPC matrix of size 11664×23328 was implemented. The LDPC decoder tested utilised the standard belief propagation decoding algorithm.

### Discussion

It should be noted that, although the description of the embodiment refers to Additive White Gaussian Noise (AWGN), other embodiments are equally applicable to cases where the received signal is contaminated by noise or interference having different statistics.

The foregoing describes only the use of LDPC, but the method can be equally applied to decoding other forms of forward error correction, such as using Viterbi or turbo decoding. For example, the LDPC encoder 14 can be replaced with a convolutional code encoder plus space-frequency interleaver, while the LDPC decoder 32 can be replaced with a corresponding space-frequency de-interleaver plus a soft-decision Viterbi decoder (not shown). If the soft-decision Viterbi decoder requires log-likelihood ratio as an input, the bit value probability can be converted into the log-likelihood ratio L(b, i, k, l) by

$$L ( b , i , k , l ) = log \frac{P ( b , i , k , l )}{1 - P ( b , i , k , l )} \qquad ( 13 )$$

In another implementation, a parallel concatenated code encoder plus a space-frequency interleaver can replace the LDPC encoder 14, while a corresponding space-frequency de-interleaver plus a turbo decoder replaces the LDPC decoder 32 (not shown).

In the preceding description, the preferred embodiments describe measuring the ‘noise only’ and ‘signal+noise’ variances per sub-carrier at each receiver, and calculating the ESNRs per sub-carrier per transmitter using these variances in combination with the (measured) propagation sub-channel transfer functions. However, it will be appreciated by those persons skilled in the art that the order of the steps described for the preferred embodiment is not limiting, and similar approaches may yield the same or similar outcome. For example, provided that the propagation sub-channel transfer functions gains are determined first, the noise and signal plus noise variances may be measured at the output of the zero-forcing process MIMO detector, and the effective SNRs per transmitter evaluated directly. It is clear that this approach involves equivalent calculations and so will give the same estimates for the effective SNRs per sub-carrier per transmitter and hence will provide the decoder with an equally accurate estimate of bit value probabilities.

It is also to be understood that techniques which do not rely on the presence of a ‘noise only’ period may be used as an alternative to the approach described above for estimating the noise variances and still fall within the broad scope of the invention. As an example, the ‘noise only’ variances may be estimated with the aid of portions of the received signal which are know to be repetitive or predictable, by measuring the differences between those receiver sample values corresponding to various distinct occurrences of the same received signal (values). This approach may be of value in situations involving streaming (e.g. digital television broadcasts), rather than burst transmission, since almost all such transmissions already carry known synchronization/training information suitable for this noise variance estimation process.

### APPENDIX

The following MATLAB™ code may be used when implementing the method described hereinbefore in a programmable microprocessor.

The material contained in the MATLAB™ code set out below is subject to copyright protection. The copyright owner has no objection to anyone who requires a copy of the program disclosed therein for purposes of understanding or analyzing the invention, but otherwise reserves all copyright rights whatsoever. This includes making a copy for any other purposes including the loading of a processing device with code in any form or language.

1. A method for decoding a data signal from analogue signals received at one or more receiving antennas, said decoding being performed on the basis of bit value probabilities derived from an effective signal to noise ratio (ESNR) and a respective symbol error value (SEV) for all said one or more receiving antennas, said ESNR being calculated utilising signal to noise ratios (SNRs) per subchannel and measured sub-channel transfer functions for each of said one or more receiving antennas, and said SEVs being calculated utilising said transfer functions.

2. A method for decoding a data signal comprising the steps of:
receiving one or more transmitted signals at each of one or more receiving antennas, each said transmitted signal having multiple frequency sub-channels containing data symbols;
calculating a signal to noise ratio (SNR) per sub-channel for each said one or more receiving antennas' respective received signal;
measuring channel transfer functions for each of said one or more receiving antennas; calculating an effective signal to noise ratio (ESNR) for all said one or more receiving antennas utilising a respective said SNR per sub-channel and a respective said channel transfer function;
calculating symbol error values (SEVs) for all said one or more receiving antennas utilising a respective said channel transfer function and a respective estimated value of said data symbols;
deriving bit value probabilities utilising said ESNR and a respective said SEV; and
decoding said data signal utilising said derived bit value probabilities.

3. A method according to claim 2, wherein the step of calculating said SEVs includes determining the distance of said estimated symbol values from a predetermined ideal constellation point.

4. A method according to claim 2, wherein the step of calculating said SNRs per sub-channel includes sampling each said receiving antenna's received signal at each of a first period when there are no data symbols present and a second period when there is at least one data symbol present, determining the variance of said received signals over the duration of the first period and the variance of said received signals over the duration of the second period for each receiving antenna, and calculating said SNR per sub-channel for each receiving antenna utilising said variances.

5. A method according to claim 4, further comprising determining the difference between the first period variance and the second period variance, and dividing said difference by the first period variance.

6. A method according to claim 2, wherein said decoding step utilises low density parity check decoding.

7. A method according to claim 2, wherein said decoding step utilises Viterbi decoding.

8. A method according to claim 2, wherein said decoding step utilises turbo decoding.

9. A method according to claim 2, further comprising the step of converting said received signals from the time domain to the frequency domain before calculating said SNRs.

10. A method according to claim 9, wherein said converting step is performed by an Fast Fourier transformation (FFT) process.

11. A method according to claim 2, wherein said sub-channels are encoded by orthogonal frequency division multiplex modulation.

12. A receiver for decoding a data signal from analogue signals received at one or more receiving antennas, said decoding being performed computationally on the basis of bit value probabilities derived from an effective signal to noise ratios (ESNR) and a respective symbol error value (SEV) for all said one or more receiving antennas, said ESNR being calculated utilising signal to noise ratios (SNRs) per sub-channel and measured sub-channel transfer functions for each of said one or more receiving antennas, and said SEVs being calculated utilising said transfer functions.

13. A receiver for decoding a data signal comprising:
one or more receiving antennas receiving one or more transmitted signals, each said transmitted signal having multiple frequency sub-channels containing data symbols;
a circuit calculating a signal to noise ratio (SNR) per sub-channel for each said one or more receiving antennas' respective received signal;
a circuit measuring channel transfer functions for each of said one or more receiving antennas;
a circuit calculating an effective signal to noise ratio (ESNR) for all said one or more receiving antennas utilising a respective said SNR per sub-channel and a respective said channel transfer function;
a circuit calculating symbol error values (SEVs) for all said one or more receiving antennas utilising a respective said channel transfer function and a respective estimated value of said data symbols;
a circuit deriving bit value probabilities utilising said ESNR and a respective said SEV; and
a decoder decoding said data signal utilising said derived bit value probabilities.

14. A receiver according to claim 13, wherein said circuit calculating said SEVs determines the distance of said estimated symbol values from a predetermined ideal constellation point.

15. A receiver according to claim 13, wherein the circuit calculating said SNRs per sub-channel samples each said receiving antenna's received signal at each of a first period when there are no data symbols present and a second period when there is at least one data symbol present, determines the variance of said received signals over the duration of the first period and the variance of said received signals over the duration of the second period for each receiving antenna, and calculates said SNR per sub-channel for each receiving antenna utilising said variances.

16. A receiver according to claim 15, further comprising a circuit determining the difference between the first period variance and the second period variance, and dividing said difference by the first period variance.

17. A receiver according to claim 13, wherein said decoder utilises low density parity check decoding.

18. A receiver according to claim 13, wherein said decoder utilises Viterbi decoding.

19. A receiver according to claim 13, wherein said decoder utilises turbo decoding.

20. A receiver according to claim 13, further comprising a circuit converting said received signals from the time domain to the frequency domain before said SNRs per subchannel are calculated.

21. A receiver according to claim 20, wherein said converter circuit is an Fast Fourier transformation (FFT) circuit.

22. A receiver according to claim 13, wherein said sub-channels are encoded by orthogonal frequency division multiplex modulation.
